(19) United States
(12) Patent Application Publication
(10) Pub. No.: US 2007/0078841 A1
(43) Pub. Date: Apr. 5, 2007

(54) SYSTEM AND METHOD FOR NETWORK RESOURCE MANAGEMENT

(75) Inventor: CHENG-WEI LIN, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,112

(22) Filed: Jun. 23, 2006

(30) Foreign Application Priority Data
Sep. 2, 2005 (CN) 200510037017.5

(51) Int. Cl. G06F 17/30

(52) U.S. Cl. 707/4

(57) ABSTRACT

A network resource management system that manages a plurality of distributed client computers through a network. The system comprises: a data collecting module (11) configured for collecting data from each client computer (6) via a domain controller (1), and for uploading the connected data to shared folders (5); an agent module (41) configured for comparing, filtering, and processing the data of the shared folders (5) via an agent server (4) and writing the data into a database (7); and a task managing module (31) configured for accessing the database (7) via a website server (3), and for searching and executing the management task on the corresponding client computers. A related method is also disclosed.

### FIELD OF THE INVENTION

The present invention relates to a network resource management system and method.

### DESCRIPTION OF RELATED ART

Network computing has become increasingly popular. For example, a number of new devices have been introduced for use on a variety of networks from local area networks to the Internet to the World Wide Web. The increasing complexity of network communications raises the issue for an improved network resource management. For this purpose, any device or system associated with the network is a “resource” of the network.

Typical network operations are limited to the transmission of electronic mail, and retrieval of data. But, for the network administrator, network management tasks also includes: monitoring each client status, issuing order to each client as needed, filtering data, and managing each user group, etc.

There is a need in the art for a network resource management system that is cost effective and requires little or no specialized knowledge to use. The system should communicate using existing network commands and the system should operate with existing client browsers to eliminate the need for additional network resource management software on the client. The system should provide a homogeneous interface to perform network resource management using existing client-based network access software. The network administrator may able to collect exact information and complete the appointed task by means of the system.

### SUMMARY OF THE INVENTION

A network resource management system that manages a plurality of distributed client computers through a network includes: a data collecting module configured for collecting data from each client computer via a domain controller and for uploading the collected data to shared folders; an agent module configured for comparing, filtering, and processing the data of the shared folders via an agent sever and for writing the data into a database; and a task managing module configured for accessing the database via a website server, and for searching and performing management tasks on the corresponding client computers.

A method for network resource management that manages a plurality of distributed client computers through a network includes the steps of: collecting data from each client computer; uploading the collected data to the shared folders; comparing, filtering, and processing the data of the shared folders and for writing the data into the database; accessing the database, and searching for management tasks; issuing the management tasks; and performing the management tasks on the corresponding client computers.

Other advantages and novel features of the present invention will become more apparent from the following detailed description of preferred embodiments when taken in conjunction with the accompanying drawings.

### BRIEF DESCRIPTION OF THE DRAWINGS

FIG. 1 shows a schematic diagram of hardware configuration of a network resource managements system in accordance with one preferred embodiment;

FIG. 2 is a flowchart of a preferred method for network resource management;

FIG. 3 illustrates one step of FIG. 2 in detail, namely collecting data from each client computer;

FIG. 4 illustrates another step of FIG. 2 in detail, namely issuing the searched management tasks; and

FIG. 5 illustrates the last step of FIG. 2 in detail, namely executing the management tasks.

### DETAILED DESCRIPTION OF THE INVENTION

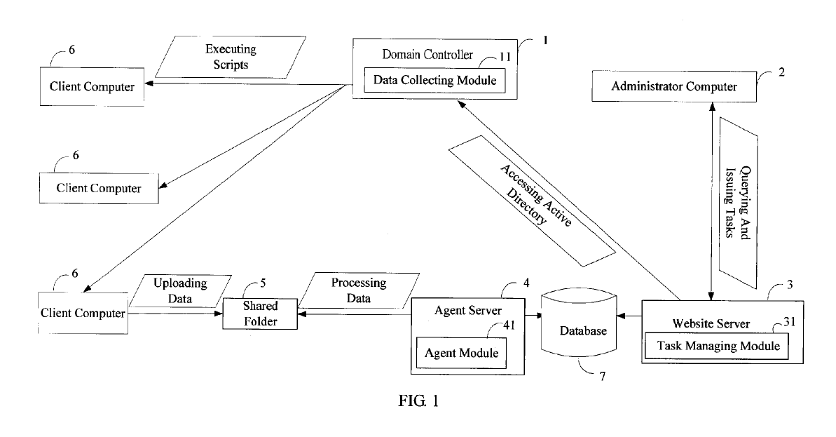

FIG. 1 shows a schematic diagram of hardware configuration of a network resource management system in accordance with one embodiment. The system typically includes a domain controller 1, an administrator computer 2, a website server 3, a database 7, an agent server 4, a plurality of shared folders 5 (only one shown), and a plurality of distributed client computers 6.

The administrator computer 2 manages network resources by means of connecting the above mentioned devices via an active directory service interface (ADSI) and by using a computer management script written in windows management instrumentation (WMI) and windows script host (WSH). The administrator computer 2 controls the client computers 6 to execute the computer management script, and uploads an execution status of the management script to the database 7. Users can access the website server 3 via the administrator computer 2, and search and browse the execution status via a webpage.

The domain controller 1 is a server which provides an active directory (AD). Administrators may query needed information by means of accessing the domain controller 1 with an interface provided by the website server 3. The domain controller 1 includes a data collecting module 11. The data collecting module 11 is configured for collecting data from each client computer 6, and uploading the collected data to the shared folders 5. Such data include, but not limited to: hardware data, software data, computer logs, patch installation data, and event data of each client computer 6. The data collecting module 11 collects the data via executing particular scripts in the domain controller 1. The scripts include: a startup script, a login script, a logout script, a shutdown script, and a monitor script.

The agent server 14 includes an agent module 41. The agent module 41 is configured for comparing, filtering, and processing data of the shared folders 5 via the agent server 4 and for writing the data into the database 7.

The website server 3 includes a task managing module 31. The task managing module 31 is configured for accessing the database 7 via the website server 3, and for searching and performing management tasks to manage the client computers 6.

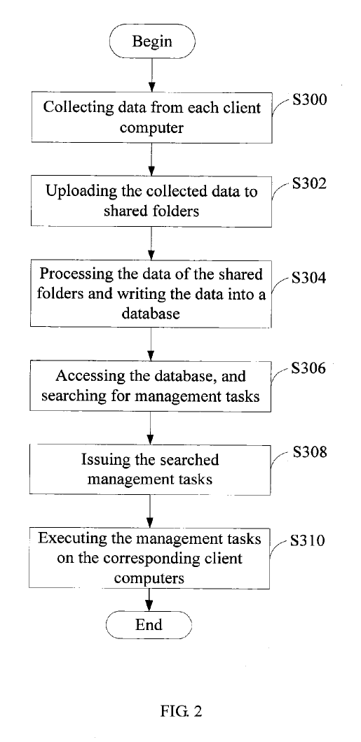

FIG. 2 is a flowchart of a preferred method for network resource management. In step S300, the data collecting module 11 in the domain controller 1 collects data from each client computer 6. In step S302, the data collecting module 11 uploads the collected data to the shared folders 5. In step S304, the agent module 41 processes the data of the shared folders 5 and writes the data into database 7. In step S306, the task managing module 31 accesses database 7, and searches for management tasks. In step S308, the task managing module 31 issues the management tasks. In step S310, the task managing module 31 executes the issued management tasks on the corresponding client computers 6.

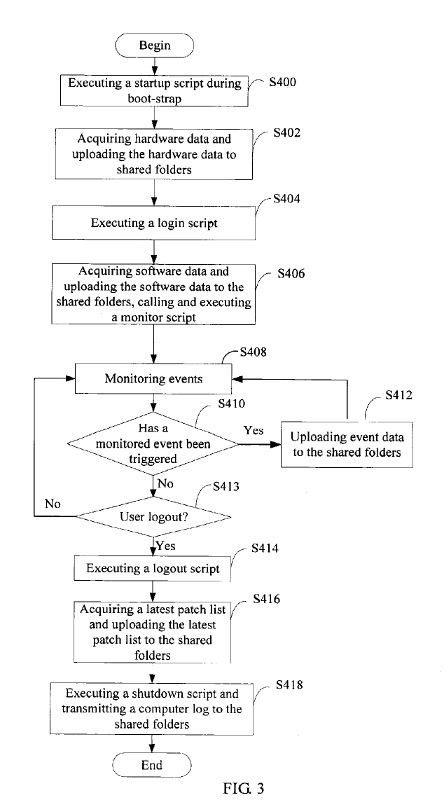

FIG. 3 illustrates step S300 in detail, namely collecting data from each client computer 6. In step S400, during a boot-strap of the client computers 6, the client computers 6 execute the startup script of the domain controller 1. In step S402, the startup script acquires hardware data of the client computers 6, uploads the hardware data and the computer log of the client computers 6 to the shared folders 5, and completes the boot-strap sequence. In step S404, the client computer 6 executes the login script when a user logs in. In step S406, the login script acquires software data and uploads the software data to the shared folders 5, calls the monitor script to begin executing, and completes the login sequence. In step S408, the monitor script begins to monitor events. In step S410, the monitor script determines whether a monitored event has been triggered. In step S412, if the monitored event has been triggered, the monitor script uploads the event data into the shared folders 5 in order for the event data to be processed by the agent module 41, and the procedure returns to step S408. Otherwise, in step S413, if no monitored events have been triggered, the monitor script determines whether the user has logged out of the client computer 6. If the user has not logged out of the client computer 6, the procedure returns to step S408. Otherwise, in step S414, if the user has logged out of the client computer 6, the client computer 6 completes the monitor sequence and executes the logout script. In step S416, the logout script acquires a latest patch list during the client computer 6 implementation and uploads the latest patch list into the shared folders 5, and completes the logout sequence. In step S418, the client computer 6 is turned off and executes the shutdown script in order to upload the computer log into the shared folders 5.

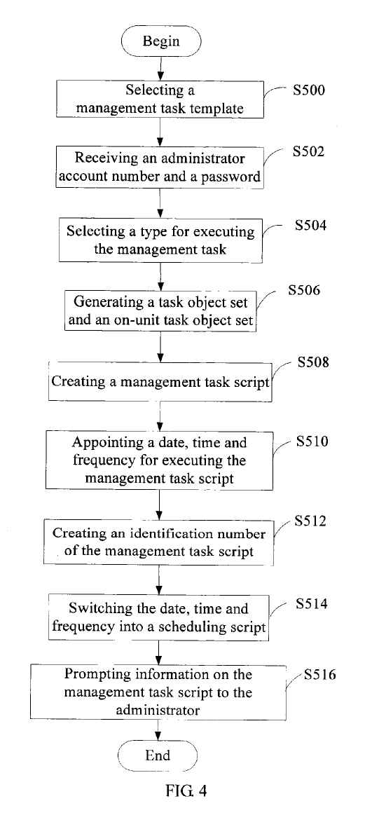

FIG. 4 illustrates step S308 in detail, namely issuing the searched management tasks. In step S500, the administrator selects a management task template. In step S502, the task managing module 31 prompts the administrator to input an administrator account number and a corresponding password. When the administrator account number and the password are received, the task managing module 31 determines whether the account number and the corresponding password are valid. If the account number or the password is invalid, the task managing module 31 prompts an error message and prompts the administrator to input the account and password again.

In step S504, the administrator selects an objective for executing the management task. The objective may be applied to different groups of client computers 6.

In step S506, the task managing module 31 produces a task object set and an on-unit task object set according to the objective type selected. The on-unit task object set is a copy of the task object set.

In step S508, the task managing module 31 adds the administrator account number and the corresponding password in the management task template, encrypts the template and creates a management task script in the agent server 4.

In step S510, the administrator appoints a date, a time, and a frequency for executing the management task script.

In step S512, the task managing module 31 connects database 7 and creates an identification number of the management task script, and writes the information of the management task script into database 7.

In step S514, the task managing module 31 transfers the date, time, and frequency into a scheduling script. The scheduling script includes a trigger event. The scheduling script is executed by the agent server 4 in response to the trigger event.

In step S516, the task managing module 31 prompts information on the management task script to the administrator.

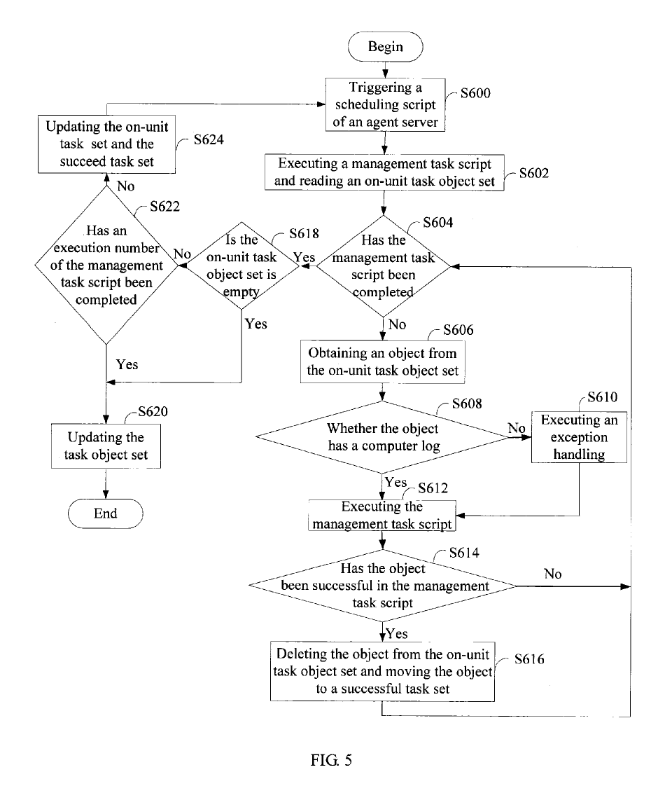

FIG. 5 illustrates step S310 in detail, namely executing the management tasks. In step S600, the task managing module 31 triggers the scheduling script of the agent server 4 in response to the trigger event. In step S602, the task managing module 31 executes the management task script, and reads the on-unit task object set from database 7 according to the identification number of the management task script. In step S604, the task managing module 31 determines whether the management task script has been completed, that is to say, the task managing module 31 determines whether all objects in the on-unit task object set have been executed by the management task script.

If the management task script has been completed, the procedure goes directly to step S618 described below. Otherwise, if the management task script has not been completed, in step S606, the task managing module 31 obtains an object from the on-unit task object set. In step S608, the task managing module 31 determines whether the object has a corresponding computer log in the shared folders 5; The object may correspond to any client computers 6. If the object has no corresponding computer log in the shared folders 5, in step S610, the task managing module 31 executes an exception handling on the corresponding client computer 6 described below and the procedure goes to step S612 described below. If the object has a corresponding computer log in the shared folders 5, in step S612, the object executes the management task script. In step S614, the task managing module 31 determines whether the object has been successful in executing the management task script. If the object has not been successful in the management task script, the procedure returns to step S604 described above.

In step S610, the task managing module 31 determines whether the client computer 6 is online. If the computer is offline, the task managing module 31 puts the object back on the on-unit task object set and the procedure goes to step S604; otherwise, if the client computer 6 is online, the task managing module 31 transmits the computer log of the corresponding client computer 6 to the shared folders 5 and goes to step S612 described before.

Otherwise, if the object has not been successful in the management task script, in step S616, the task managing module 31 deletes the object from the on-unit task object set and moves the object into the successful task set, and the task managing module 31 writes the execution results of the management task script into database 7; the procedure returns to step S604.

In step S618, the task managing module 31 determines whether the on-unit task object set is empty. If the on-unit task object set is not empty, the procedure goes directly to step S622 described below. Otherwise, if the on-unit task object set is empty, in step S620, the task managing module 31 updates the task object sets in the database 7. The task object sets include: the on-unit task object set, the successful task set, and the state of the management task.

In step S622, the task managing module 31 determines whether an execution number of the management task script has been completed. If the execution number of the management task script has been completed, the procedure goes directly to step S620 described above. Otherwise, if the execution number of the management task script has not been completed, in step S624, the task managing module 31 updates the on-unit task object set and the successful task set in the database 7; the procedure returns to step S600.

It is to be understood that other embodiments may be utilized and structural changes may be made without departing from the scope of the present invention.

What is claimed is:

1. A network resource management system that manages a plurality of distributed client computers through a network, the system comprising:
a data collecting module configured for collecting data from each client computer via a domain controller and for uploading the collected data to shared folders;
an agent module configured for comparing, filtering, and processing the data in the shared folders via an agent server and writing resulting data into a database; and
a task managing module configured for accessing the database via a website server, and for searching and performing management tasks on the client computers.

2. The system of claim 1, wherein the data collected by the data collecting module comprise hardware data, software data, computer logs, patch installation data, and event data of each client computer.

3. The system of claim 1, wherein the task managing module is further configured for issuing the management tasks according to the search results.

4. A method for network resource management that manages a plurality of distributed client computers through a network, the method comprising the steps of:
collecting data from each client computer;
uploading the collected data to shared folders;
comparing, filtering, and processing the data of the shared folders and writing resulting data into a database;
accessing the database, and searching for management tasks;
issuing the management tasks; and
executing the management tasks on the client computers.

5. The method of claim 4, wherein the data from each client computer comprises hardware data, software data, computer logs, patch installation data, and event data of the client computer.

6. The method of claim 4, wherein the searching step comprises the steps of:
selecting a management task template;
querying and verifying an administrator account number and a corresponding password;
selecting an objective for a management task;
generating a task object set and an on-unit task object set;
adding the administrator account number and the corresponding password to the management task template;
encrypting the management task template;
creating a management task script;
appointing a date, time, and frequency of executing the management task script;
creating an identification number of the management task script, and writing information on the management task script into the database; and
generating a scheduling script and executing the scheduling script.

7. The method of claim 6, wherein the step of executing the management tasks comprises the steps of:
triggering the scheduling script in response to a trigger event;
executing the management task script and reading the on-unit task object set from the database according to the serial number;
determining whether the management task script has been completed;
obtaining an object from the on-unit task object set and executing the management task script if the management task script has not been completed;
determining whether the on-unit task object set is empty if the management task script has been completed;
determining whether an execution number of the management task script has been completed if the on-unit task object set is not empty;
updating the on-unit task object set and a successful task set and returning to the triggering step if the execution number has not been completed; and
updating the on-unit task object set and the successful task set and the state of the management task if the execution number has been completed.

8. The method of claim 7, further comprising the step of:
updating the on-unit task object set and the successful task set and the state of the management task if the on-unit task object set is empty.

9. The method of claim 7, wherein the reading step comprises the steps of:
determining whether the object has a corresponding computer log in the shared folders;
executing the management task script if the object has the corresponding computer log;
determining whether the object has been successful in executing the management task script;
deleting the object from the on-unit task object set and moving the object into the successful task set if the object has been successful in the management task script;
returning execution results of the management task script to the database; and
returning to the step of determining whether the management task script has been completed.
